(19) United States
(12) Patent Application Publication
(10) Pub. No.: US 2011/0153661 A1
(43) Pub. Date: Jun. 23, 2011

(54) NAVIGATION DEVICE AND DATABASE UPDATE PROGRAM

(75) Inventors: Takamitsu Sakai, Anjo-shi (JP); Masaru Ohashi, Anjo-shi (JP); Seiji Takahata, Anjo-shi (JP); Tomofumi Shibata, Anjo-shi (JP); Mitsuhiro Naito, Anjo-shi (JP); Tetsuo Kumagai, Anjo-shi (JP); Toru Sakai, Anjo-shi (JP); Hiroyoshi Masuda, Anjo-shi (JP)

(73) Assignee: AISIN AW CO., LTD., Aichi-ken (JP)

(21) Appl. No.: 12/997,760

(22) PCT Filed: May 26, 2009
(86) PCT No.: PCT/JP2009/060096

§ 371 Date: Jan. 28, 2011

(30) Foreign Application Priority Data
Jun. 27, 2008 (JP) 2008-169024

(51) Int. Cl. G06F 17/30

(52) U.S. Cl. 707/770; 707/E17.014

(57) ABSTRACT

A navigation device that is provided with reference databases that include search databases that are referenced when the navigation device performs a location search for a location on a map, that accepts provided update data, and that performs update processing for the reference databases is provided with a priority processing unit that, in a case where a command to perform the location search is input during the update processing for the reference databases, gives priority to performing the update processing for location data that are stored in the search databases, as well as with a search unit that, after the update processing for the location data is completed by the priority processing unit, is enabled to perform the location search using the updated location data.

### TECHNICAL FIELD

The present invention relates to a navigation device that is provided with reference databases that include a search database that is referenced in conducting a search for a location on a map, and that accepts provided update data and performs update processing for the reference databases. The present invention also relates to a database update program that is used in the update processing for the reference databases.

### BACKGROUND ART

It is generally desired that the contents of a map database, a search database, and the like that are used in a navigation device represent the actual states of roads, facilities, and the like that are constantly changing. Accordingly, a system is already known that provides update data as necessary through a communication network, a data storage medium, or the like and then uses the update data to perform updates of the databases in the navigation device. For example, in Japanese Patent Application Publication No. JP-A-2007-328739, a system is described that updates a map database using update data that is provided from a server device. Further, Japanese Patent Application Publication No. JP-A-2008-059045 describes a system that updates a search database using update data that is provided from a server device.

### SUMMARY OF THE INVENTION

However, in the database update systems in navigation devices to date, it has not been possible to use the updated data for performing a location search, a route search, or the like until all of the update processing is completed. Moreover, with this sort of database update processing, even if only a little time is needed to update an individual data item, considerable time is required to perform all of the update processing, because the number of data items is large. Therefore, a correspondingly long time must pass after the update data are acquired before a user of the navigation device is able to perform the location search, the route search, or the like using the data that has been updated by the update data.

It is an object of the present invention to address these issues and provide a navigation device that improves convenience for the user by making it possible, after the update data are acquired, to perform a location search using updated location data before all of the update processing that uses the update data has been completed.

According to the present invention for achieving the object described above, the navigation device is provided with reference databases that include search databases that are referenced when the navigation device performs a location search for a location on a map. The navigation device accepts provided update data and performs update processing for the reference databases. A characteristic configuration of the navigation device includes a priority processing unit that, in a case where a command to perform the location search is input during the update processing for the reference databases, gives priority to performing the update processing for location data that are stored in the search databases, and a search unit that, after the update processing for the location data is completed by the priority processing unit, is enabled to perform the location search using the updated location data.

According to the characteristic configuration, in a case where the command to perform the location search is input during the update processing for the reference databases according to the update data, priority is given to performing the update processing for the location data that are stored in the search databases, as opposed to the update processing for other data, so it is possible to complete the update processing sooner for the location data only. The location search that uses the updated location data is therefore enabled before the update processing is completed for all of the reference databases, including the data other than the location data, such as map data and the like. Accordingly, even in a case where the update processing is completed for all of the reference databases will take some time, the user of the navigation device is able to search for a location such as a newly opened facility or the like, for example, in a comparatively short time after the update data are acquired. This can enhance the convenience for the user. Note that unlike the map data, for which connection relationships in a road network and the like become issues, the location data for each location are independent. Therefore, even in a state in which only the location data have been updated, and the other data have not been updated, it is possible to perform properly the location search that searches among the updated location data.

Here, it is preferable for the navigation device to be configured such that the priority processing unit gives priority to performing, as the update processing for the location data, the update processing for the location data that will be newly added.

According to this configuration, priority is given to the update processing for the location data that will be newly added, and modifications and deletions of the location data are performed after that. Therefore, the user of the navigation device is able to perform the location search that searches among the newly added location data in a shorter time after the update data are acquired. Further, the demand for the location search that searches among the location data that have been newly added by the update processing, such as newly opened facilities and the like, is ordinarily high, while the demand for the location search that reflects modifications and deletions of existing location data is relatively low. Therefore, giving priority to the update processing for the location data that will be newly added reduces practical problems by shortening the update processing time for the location data.

In the configuration in which the priority processing unit gives priority to performing the update processing for the location data that will be newly added, as described above, it is also preferable for the navigation device to be configured such that the search unit, immediately after the update processing for the location data is completed by the priority processing unit, is enabled to perform the location search among the newly added location data that include the location data that were newly added by the update processing.

According to this configuration, the location search that searches among the newly added location data that are configured from the comparatively new location data, including the location data that were newly added by the update processing, can be performed immediately after the update processing for the location data is completed by the priority processing unit. Therefore, the user of the navigation device is able to perform the location search that searches among the newly added location data in comparatively short time after the update data are acquired, such that when the location search is performed to search for a desired facility among the facilities and the like that have opened comparatively recently, for example, the location search can be performed quickly and appropriately with respect to the most recent location data.

It is also preferable for the navigation device to be configured such that it also includes update databases that are provided in correspondence to the reference databases and that are direct objects of the update processing according to the update data, and such that the update processing for the reference databases includes the update processing for the update databases according to the update data and replacement processing that replaces the reference databases with contents of the updated update databases.

According to this configuration, during the update processing according to the update data, while the reference databases are maintained in a state in which they can be utilized, the update processing for the update databases that are provided separately from the reference databases can be performed in the background. Therefore, restricting of the use of the reference databases during the update processing is limited to the comparatively short time during which the replacement processing that replaces the reference databases with the contents of the updated update databases is being performed. Accordingly, compared to a case in which the reference databases are the direct objects of the update processing according to the update data, it is possible to shorten the time during which the use of the reference databases is restricted and the functions of the navigation device, such as the location search, the route search, and the like, are restricted because the reference databases are being directly read and overwritten. This can enhance the convenience for the user.

It is also preferable for the navigation device to be configured such that the update processing for the update databases is performed automatically after the update data are acquired, and the replacement processing is performed on the condition that a command that permits the updating of the reference databases has been input.

During the update processing for the update databases, the reference databases can be maintained in a state in which they can be utilized, so there are no restrictions on the function of the navigation device, but during the replacement processing, the use of the reference databases is restricted and the functions of the navigation device, such as the location search, the route search, and the like, are restricted, because the reference databases are being directly read and overwritten. According to this configuration, the replacement processing, during which the functions of the navigation device are restricted, is performed on the condition that the command that permits the updating of the reference databases has been input by the user, so it is possible to prevent a situation from occurring in which the functions of the navigation device are restricted when the user does not intend for them to be restricted.

It is also preferable for the navigation device to be configured such that the search databases include location databases in which the location data are stored and an index database in which are stored index data for searching among the location data.

According to this configuration, in a case where a large numbers of the location data are present in the reference databases, it is possible to use the index data to search quickly for the desired location data.

In the configuration in which the search databases include the location databases and the index database, as described above, it is also preferable for the navigation device to be configured such that the location databases include a newly added location database that stores the newly added location data that include the location data that were newly added by the update processing for the location data that was performed by the priority processing unit and an ordinary location database that stores all of the location data.

According to this configuration, when the location search is performed that searches among the newly added location data, the location search may be conducted only for the location data in the newly added location database, so it is possible to simplify the processing for the location search that searches among the newly added location data.

It is also preferable for the navigation device to be configured such that the newly added location database is a direct object of the update processing according to the update data, and the priority processing unit gives priority to performing, as the update processing for the location data, processing that adds to the newly added location database the location data that will be newly added, the location data being included in the update data.

According to this configuration, the priority processing unit can easily and quickly perform the update processing for the location data that will be newly added, the location data being included in the update data.

In the configuration in which the search databases include the location databases and the index database, as described above, it is also preferable for the navigation device to be configured such that the location databases store the location data in a state in which the newly added location data that include the location data that were newly added by the update processing for the location data that was performed by the priority processing unit can be distinguished from the location data other than the newly added location data.

According to this configuration, although the navigation device is configured such that both the newly added location data and the location data other than the newly added location data are stored in one location database, it is easily possible to perform the processing for the location search that extracts only the newly added location data and searches only among the newly added location data.

In the configuration in which the location databases store the location data in a state in which the newly added location data can be distinguished from the location data other than the newly added location data, as described above, it is also preferable for the navigation device to be configured such that the priority processing unit gives priority to performing processing that replaces the location databases that are included in the reference databases with contents of the updated location update database after processing that adds to a location update database that is included in the update databases the location data that will be newly added that are included in the update data, as the update processing for the location data.

According to this configuration, the priority processing unit can cause the contents of the location data that will be newly added that are included in the update data to be reflected quickly in the location databases that are included in the reference databases.

It is also preferable for the newly added location data to be defined as the location data for which one of the times that the location data were newly added and the times that the locations to which the location data apply were actually enabled are within a specified period of time, for example.

According to the present invention, a characteristic configuration of a database update program that accepts provided update data and performs update processing for reference databases that include search databases that are referenced when a location search is performed for a location on a map causes a computer to function as a priority processing function that, in a case where a command to perform the location search is input during the update processing for the reference databases, gives priority to performing the update processing for location data that are stored in the search databases and a search enabling function that, after completion of the update processing for the location data that is performed by the priority processing unit, makes it possible for the location search to be performed using the updated location data.

According to the characteristic configuration, in a case where the command to perform the location search is input during the update processing for the reference databases according to the update data, priority is given to performing the update processing for the location data that are stored in the search databases, as opposed to the update processing for other data, so it is possible to complete the update processing sooner for the location data only. The location search that uses the updated location data is therefore enabled before the update processing is completed for all of the reference databases, including the data other than the location data, such as map data and the like. Accordingly, even in a case where the update processing is completed for all of the reference databases will take some time, it is possible to search for a location such as a newly opened facility or the like, for example, in a comparatively short time after the update data are acquired. This can enhance the convenience for the user of the reference databases. Note that unlike the map data, for which connection relationships in a road network and the like become issues, the location data for each location are independent. Therefore, even in a state in which only the location data have been updated, and the other data have not been updated, it is possible to perform properly the location search that searches among the updated location data.

### BRIEF DESCRIPTION OF THE DRAWINGS

FIG. 1 is a block diagram that schematically shows a functional configuration of a navigation device according to a first embodiment of the present invention;

FIG. 2 is an explanatory figure that shows a procedure for using an update data file to update reference databases according to the first embodiment of the present invention;

FIG. 3 is a figure that shows a comparison of an ordinary update processing time chart and an update processing time chart in a case where priority is given to performing update processing for location data, according to the first embodiment of the present invention;

FIG. 4 is an explanatory figure that shows a procedure for using the update data file to update the reference databases according to a second embodiment of the present invention; and

FIG. 5 is a figure that shows a comparison of an ordinary update processing time chart and an update processing time chart in a case where priority is given to performing the update processing for the location data, according to the second embodiment of the present invention.

### DETAILED DESCRIPTION OF THE EMBODIMENTS

### 1. First Embodiment

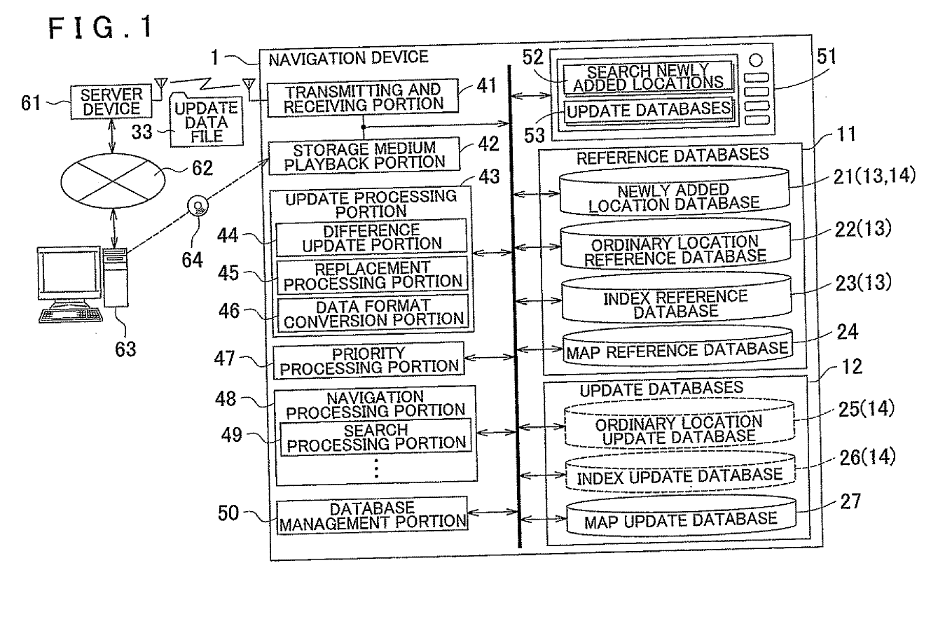

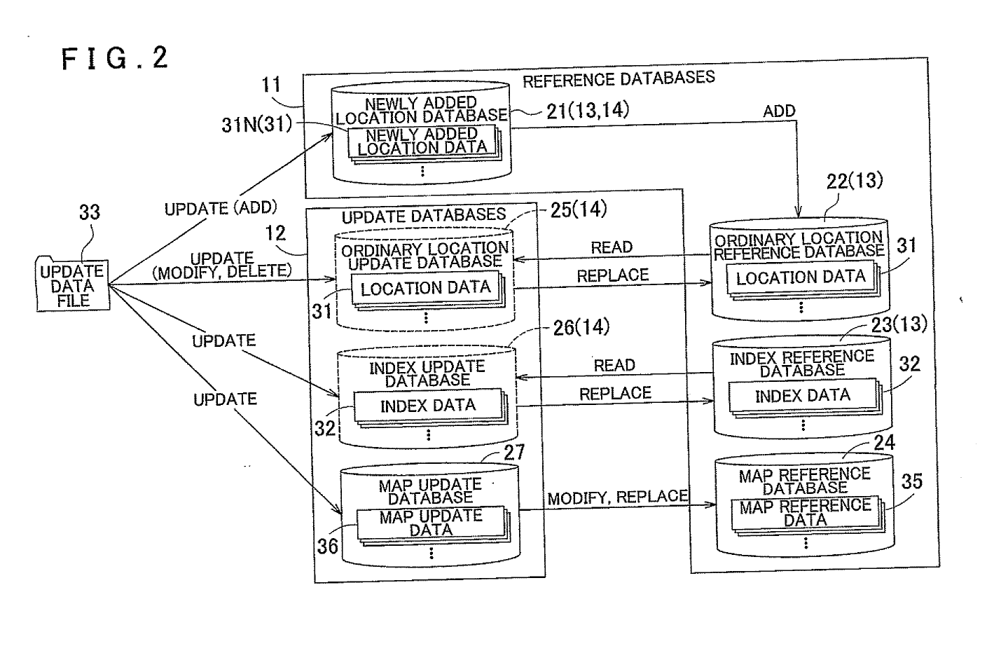

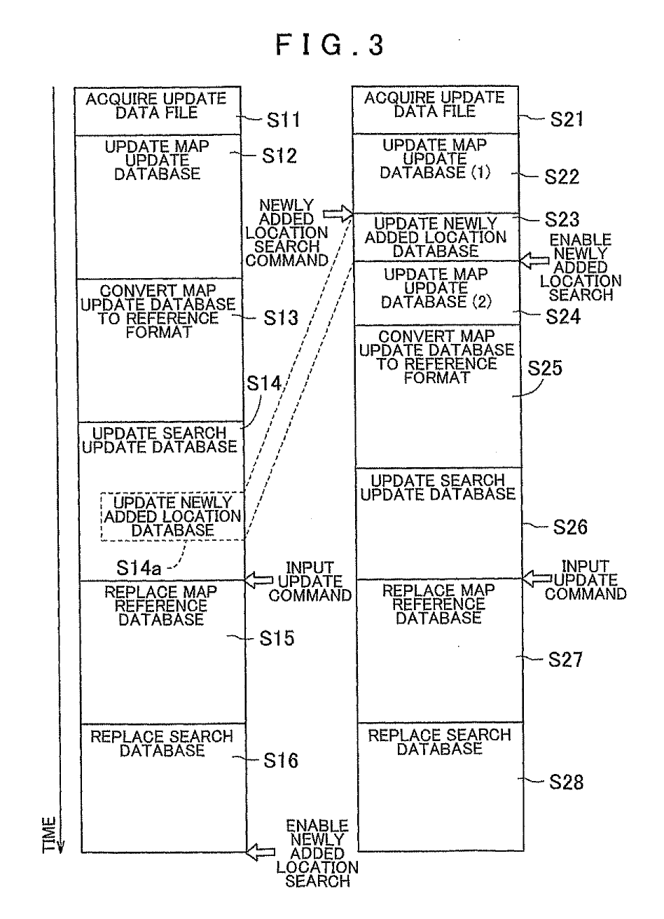

First, a first embodiment of the present invention will be explained based on the drawings. FIG. 1 is a block diagram that schematically shows a functional configuration of a navigation device 1 according to the first embodiment of the present invention. The navigation device 1 is provided with reference databases 11 that include search databases 13 that are referenced in conducting a search for a location on a map, and is configured such that it accepts a provided update data file 33 and performs update processing for the reference databases 11. FIG. 2 is an explanatory figure that shows a procedure for using the update data file 33 to update reference databases 11. The navigation device 1 is configured such that, in a case where a location search command is input by a user while the update processing for the reference databases 11 is being performed, priority is given to performing the update processing for location data 31 (refer to FIG. 2) that are stored in the search databases 13, and after the update processing for the location data 31 is completed, it is possible to perform the location search using the updated location data 31. FIG. 3 is a figure that shows a comparison of an ordinary update processing time chart and an update processing time chart in a case where priority is given to performing the update processing for the location data 31. In the present embodiment, in addition to the reference databases 11, the navigation device 1 is provided with update databases 12 that serve as direct objects of the update processing according to the update data file 33. The update processing for the reference databases 11 includes the update processing for the update databases 12 according to the update data file 33 and replacement processing that replaces the contents of the reference databases 11 with the contents of the updated update databases 12.

Each of an update processing portion 43, a priority processing portion 47, and a navigation processing portion 48 that are functional portions of the navigation device 1 that is shown in FIG. 1 is configured such that its central member is a computational processing device such as a CPU or the like that is one of independent and shared among the update processing portion 43, the priority processing portion 47, and the navigation processing portion 48. The update processing portion 43, the priority processing portion 47, and the navigation processing portion 48 are configured such that functional portions for performing various types of processing on data that is input are implemented by one of hardware, software (programs), and both hardware and software. A transmitting and receiving portion 41 and a storage medium playback portion 42 are also functional portions of the navigation device 1 that is shown in FIG. 1, and their configurations for fulfilling their functions are implemented by one of hardware and a combination of hardware and software (programs). All of these functional portions are connected such that they are capable of exchanging various types of information and data. Each of the reference databases 11 and the update databases 12 is configured from a storage device that is one of independent and shared by the reference databases 11 and the update databases 12. The storage device may be provided as a hardware-configured device that has a drive unit and a storage medium, such as a non-volatile semiconductor memory such as an EEPROM or the like, a hard disk drive, or the like, for example, that rewritably stores data. The configurations of the various portions of the navigation device 1 will be explained in order below.

1-1. Reference Databases

The reference databases 11 are databases that store various types of data that are referenced when the navigation processing portion 48, which is described later, performs various types of navigation processing such as the location search, a route search, and the like. Here, the various types of data that are stored in the reference databases 11 are data in a reference format that is suitable for referencing by the navigation portion 48. This sort of reference format may be, for example, a data format in which the various types of data are arranged in the same order as an order in which the navigation processing portion 48 processes the various types of data. In the present embodiment, the reference databases 11 include a newly added location database 21, an ordinary location reference database 22, an index reference database 23, and a map reference database 24. Further, the search databases 13 that are referenced when a search is conducted for a location on a map are configured from the newly added location database 21, the ordinary location reference database 22, and the index reference database 23. In addition, the newly added location database 21 and the ordinary location reference database 22 are both location databases in which the location data 31 are stored, as shown in FIG. 2.

Here, the location data 31 are data that indicate specific attributes of individual locations. Accordingly, the location data 31 include information such as the position (the coordinates), the name, the address, the telephone number, and the like for each location. In some cases, the location data 31 also include various types of incidental information, such as the type of facility, the number of floors in a building, business information, business hours, and the like, for example. The location data 31 are stored in the databases in a state in which the various types of information that represent the individual location are consolidated in a single data frame. Accordingly, control information, such as the data volume and the like of the data frame, is stored in each data frame in the location data 31.

The newly added location database 21 is a database in which are stored newly added location data 31N (refer to FIG. 2) that are the location data 31 that are comparatively new. Here, the newly added location data 31N are those data, among all of the location data 31, that are defined as comparatively new according to a specified condition. In the present embodiment, the newly added location data 31N are the location data 31 for which one of the times that they were newly added to the newly added location database 21 and the times that the locations to which the location data 31 apply were actually enabled are within a specified period of time. Here, the specified period of time that defines the newly added location data 31N can be set to three months, one year, or the like, for example. It is preferable for the times that the locations to which the location data 31 apply were actually enabled to be the times that facilities or the like to which the location data 31 apply were enabled for use by the user of the navigation device 1, such as the time that a facility to which the location data 31 apply, such as a shop or the like, was established, the time that a road-related facility (an expressway, an interchange, or the like) to which the location data 31 apply was opened to traffic, or the like, for example.

The newly added location database 21 is a database that stores only the newly added location data 31N of this sort. Therefore, the location data 31 that are newly added by the update processing of the location data 31 by the priority processing portion 47, as described later, is also stored as the newly added location data 31N in the newly added location database 21. In the present embodiment, the newly added location database 21 is one of the direct objects of the update processing according to the update data file 33. Specifically, a difference update portion 44 of the update processing portion 43, during the update processing of the location data 31, adds to the newly added location database 21, as the newly added location data 31N, the newly added location data 31 that is included in the update data file 33. In addition, in a case where the priority processing portion 47 functions, the priority processing portion 47 performs processing that adds the newly added location data 31 that is included in the update data file 33 to the newly added location database 21 as the newly added location data 31N. Therefore, in the present embodiment, the newly added location database 21 is a database that belongs not only among the reference databases 11, but also among the update databases 12.

As time passes, each of the newly added location data 31N items that is stored in the newly added location database 21 ceases to satisfy either of the conditions described above for the newly added location data 31N. The newly added location data 31N items that have ceased to satisfy the conditions are deleted from the newly added location database 21. In the present embodiment, a database management portion 50 monitors whether or not all of the newly added location data 31N items in the newly added location database 21 satisfy the conditions, and any of the newly added location data 31N items that have ceased to satisfy the conditions are deleted from the newly added location database 21.

The ordinary location reference database 22 is a database that stores all of the location data 31 that the navigation device 1 has. Accordingly, in the present embodiment, the location data 31 that have the same content as the newly added location data 31N that are stored in the newly added location database 21 are stored in the ordinary location reference database 22. Naturally, the old location data 31 that no longer meet the conditions for the newly added location data 31N are all stored in the ordinary location reference database 22.

The index reference database 23 is a database in which are stored index data 32 (refer to FIG. 2) that are used for searching the location data 31. Here, the index data 32 are search data that are used when search processing is performed in accordance with a search condition that is designated by the user to extract the location data 31 that match the search condition. Therefore, the index data 32 include category data for narrowing the search to the location data 31 that match the search condition and storage site data (applicable data) that indicate storage sites for the location data 31 that match the search condition. Here, the category data from which the index data 32 are configured include, for example, data for each of various types of search categories, such as a name search (a search in order according to the Japanese syllabary), an address search, a telephone number search, a genre search, and the like. The category data may be configured, for example, from hierarchically structured data that are suitable for a hierarchical search or the like.

The map reference database 24 is a database in which are stored map reference data 35 that are map data in a reference format. Here, the map reference data 35 are data in formats that are suitable for reference by the navigation processing portion 48 and may be configured to include map data that have different reference formats that are suitable for various types of processing by the navigation processing portion 48, such as route search processing, route guidance processing, map display processing, and the like, for example. The map reference data 35 are map data in which an object area is divided into a plurality of partitions, with a set of the map data for each of the plurality of partitions. Further, each the sets of the map data includes road network data that are configured from a plurality of nodes that each correspond to one of a plurality of intersections that exist within the partition and from a plurality of links that each correspond to a road that connects two of the nodes. In addition to the road network data, the map reference data 35 also include drawing information that is required for the map display processing, various types of guidance information that are required for the route guidance processing, and the like. Here, the drawing information includes background information that is required in order to display road shapes, buildings, rivers, and the like, character information that is required in order to display names of municipalities, road names, and the like, and other information. The guidance information includes, among other things, intersection information that is configured from detailed information on intersections.

1-2. Update Databases

The update databases 12 are databases that are the direct objects of the update processing according to the update data file 33, and they are provided such that they correspond to the reference databases 11. That is, the update databases 12 are databases that serve as the direct objects of the update processing in place of the reference databases 11, in order to shorten the time during which use of the reference databases 11 is restricted during the update processing according to the update data file 33. Accordingly, in the present embodiment, after the update databases 12 are updated according to the update data file 33, the update processing of the reference databases 11 is completed by replacing the contents of the reference databases 11 with the contents of the update databases 12. Here, the various types of data that are stored in the update databases 12 are data in an update format that is suitable for the update processing according to the update data file 33. This sort of update format may be, for example, a data format in which individual data items are arranged in order according to a data type.

In the present embodiment, the update databases 12 include an ordinary location update database 25, an index update database 26, and a map update database 27. In addition, as explained above, the newly added location database 21 that is included in the reference databases 11 is also a database that belongs among the update databases 12, because it is a direct object of the update processing according to the update data file 33. Accordingly, update search databases 14 that are update databases that correspond to the search databases 13 described above are configured from the newly added location database 21, the ordinary location update database 25, and the index update database 26.

In the present embodiment, among the various databases that are included in the update databases 12, the contents of the ordinary location update database 25 are identical to those of the ordinary location reference database 22, and the contents of the index update database 26 are identical to those of the index reference database 23. In other words, for the plurality of the location data 31 items that are stored in the ordinary location reference database 22 and the plurality of the index data 32 items that are stored in the index reference database 23, the data structures of the individual data items are not complex, so there is no need to create corresponding data items in the update format that is different from the reference format. Accordingly, the contents of the ordinary location reference database 22 and the index reference database 23 that are referenced by the navigation processing portion 48 are identical to those of the ordinary location update database 25 and the index update database 26 for the updating according to the update data file 33.

Therefore, in the present embodiment, the ordinary location update database 25 and the index update database 26 are configured such that they are provided within the update databases 12 only during the update processing according to the update data file 33, and they are deleted after the update processing (the replacement processing) for the ordinary location reference database 22 and the index reference database 23 is finished. In other words, as shown in FIG. 2, the ordinary location update database 25 is created during the update processing according to the update data file 33 by reading the ordinary location reference database 22 and replicating (copying) it within the update databases 12. The index update database 26 is also created during the update processing according to the update data file 33 by reading the index reference database 23 and replicating (copying) it within the update databases 12. The update processing according to the update data file 33 is then performed for the ordinary location update database 25 and the index update database 26 that are created in this manner, and after the replacement processing is performed that replaces the contents of the ordinary location reference database 22 and the index reference database 23 with the updated contents of the ordinary location update database 25 and the index update database 26, the ordinary location update database 25 and the index update database 26 are deleted from the update databases 12. Therefore, within the update databases 12, other than during the update processing according to the update data file 33, only storage areas are maintained for creating the ordinary location update database 25 and the index update database 26. Note that in order to illustrate this, the ordinary location update database 25 and the index update database 26 are indicated by broken lines in FIGS. 1 and 2.

The map update database 27 is a database in which are stored map update data 36 that are map print data in the update format. The contents of the map update data 36 are substantially the same as those of the map reference data 35. That is, the map update data 36 are map data in which an object area is divided into a plurality of partitions, with a set of the map data for each of the plurality of partitions. Further, each of the sets of the map data includes road network data that are configured from a plurality of nodes that each correspond to one of a plurality of intersections that exist within the partition and from a plurality of links that each correspond to a road that connects two of the nodes. In addition to the road network data, the map update data 36 also include drawing information that is required for the map display processing, various types of guidance information that are required for the route guidance processing, and the like. Here, the drawing information includes background information that is required in order to display road shapes, buildings, rivers, and the like, character information that is required in order to display names of municipalities, road names, and the like, and other information. The guidance information includes, among other things, intersection information that is configured from detailed information on intersections.

The map update data 36 is data in a format that is suitable for the update processing according to the update data file 33. Specifically, each of the sets of the map data for the partitions from which the map update data 36 are configured may be in a data format in which the data items from which the map data are configured are arranged in order according to a data type, for example. Here, the data type may be road data that pertains to a link, intersection data that pertains to a node, shape data that pertains to the shape of a link, connection data that pertains to a link that connects individual nodes, or the like, for example.

1-3. Transmitting and Receiving Portion and Storage Medium Playback Portion

The navigation device 1 according to the present embodiment is provided with the transmitting and receiving portion 41 and the storage medium playback portion 42 as units for accepting the provided update data file 33. The transmitting and receiving portion 41 performs transmission and receiving of data to and from a server device 61 by wireless communication and is configured such that it is capable of receiving the update data file 33 from the server device 61 by wireless communication. The method of wireless communication that is used can utilize a public communication network such as a mobile telephone network, a wireless local area network (LAN), or the like, for example. The storage medium playback portion 42 plays back a storage medium 64, such as an optical disk, a magnetic disk, or the like, and is configured such that it is capable of reading the update data file 33 that is stored in the storage medium 64. As shown in FIG. 1, the user may acquire the update data file 33 from the server device 61 by downloading it through a communication network 62, such as the Internet or the like, to a terminal device 63 that is a personal computer or the like that the user owns, and then storing it in the storage medium 64.

The acquired update data file 33 is a file that contains the update data for performing the update processing for the reference databases 11. As described above, in the present embodiment, the newly added location database 21 in the update databases 12 and the reference databases 11 is the direct object of the updating according to the update data file 33. Therefore, the update data file 33 is a data file for updating the ordinary location update database 25, the index update database 26, and the map update database 27 that are included in the update databases 12, as well as the newly added location database 21 that is included in the reference databases 11. It consolidates in a single file various types of update data that represent the contents with which the various databases will be modified and updated. Therefore, in the present embodiment, the update data file 33 is a file of difference data that represent differences between the contents of the databases that will be the direct objects of the updating and modified contents for roads, facilities, and the like that have actually been modified. Using the update data file 33, the update processing portion 43, which will be described later, performs difference update processing for the newly added location database 21, the ordinary location update database 25, the index update database 26, and the map update database 27.

The difference update processing for the various databases includes addition, modification, and deletion processing for the data that are stored in the various databases. Accordingly, the update data file 33 contains data that represent the specific contents of additions, modifications, and deletions for the location data 31, additions, modifications, and deletions for the index data 32, and additions, modifications, and deletions for the map update data 36. The update data file 33 is divided according to the form of the update for the various types of data, that is, addition, modification, and deletion, and is also formatted such that the data that represent the contents of the various forms of the updates are arranged in order according to the data type.

1-4. Update Processing Portion

The update processing portion 43 is a functional portion that accepts the provided update data file 33 and performs the update processing for the reference databases 11. In the present embodiment, the update processing for the reference databases 11 includes the update processing for the update databases 12 according to the update data file 33 and the replacement processing that replaces the contents of the reference databases 11 with the updated contents of the update databases 12. More specifically, the update processing portion 43 first uses the update data file 33 to perform the update processing for the newly added location database 21, the ordinary location update database 25, the index update database 26, and the map update database 27. Next, the update processing portion 43 performs the replacement processing that replaces the contents of the ordinary location reference database 22, the index reference database 23, and the map reference database 24 that are included in the reference databases 11 with the updated contents of the ordinary location update database 25, the index update database 26, and the map update database 27. This completes the update processing for the reference databases 11. At this time, the replacement processing is not performed for the newly added location database 21 that is included in the reference databases 11, because the newly added location database 21 is updated directly according to the update data file 33. Further, because the data formats for the map update database 27 and the map reference database 24 are different, data format conversion processing is performed that converts the data from the update format to the reference format before the replacement processing is performed.

In order to perform the update processing described above, in the present embodiment, the update processing portion 43 includes the difference update portion 44, a replacement processing portion 45, and a data format conversion portion 46, as shown in FIG. 1. FIG. 2 shows the procedure for the update processing for the reference databases 11 by the update processing portion 43. The functions of the various functional portions that are included in the update processing portion 43 will be explained below with reference mainly to FIG. 2.

The difference update portion 44 is the functional portion that uses the update data file 33 that has been acquired by the transmitting and receiving portion 41 and the storage medium playback portion 42 to perform the difference update processing for the various databases that are the objects of the direct updating according to the update data file 33. Specifically, the difference update portion 44 performs the difference update processing for the various databases by taking the contents of the additions, modifications, and deletions in the location data 31, the index data 32, and the map update data 36, the contents being the difference data contained in the update data file 33, and respectively applying them to the newly added location database 21, the ordinary location update database 25, the index update database 26, and the map update database 27.

Specifically, with regard to the update processing for the location data 31, the difference update portion 44 performs the update processing that adds the location data 31 by applying to the newly added location database 21 the data that represent addition contents in the location data 31 that are contained in the update data file 33. That is, for the location data 31 that will be newly added, the difference update portion 44 treats the location data 31 as the newly added location data 31N and performs the processing that adds the newly added location data 31N to the newly added location database 21. Also with regard to the update processing for the location data 31, the difference update portion 44 performs the update processing that modifies and deletes the location data 31 in the same manner, by applying to the ordinary location update database 25 the data that represent modification contents and deletion contents in the location data 31 that are contained in the update data file 33. The difference update portion 44 also performs processing that takes the location data 31 that was added to the newly added location database 21 and adds it to the ordinary location reference database 22 after the ordinary location reference database 22 has been updated by the replacement processing that is performed by the replacement processing portion 45, which is described later. This causes all of the update processing for the additions, modifications, and deletions in the location data 31 that are contained in the update data file 33 to be reflected in the ordinary location reference database 22. Accordingly, all of the location data 31 that the navigation device 1 has, including the location data 31 that have the same contents as the newly added location data 31N that are stored in the newly added location database 21, are stored in the ordinary location reference database 22.

With regard to the update processing for the index data 32, the difference update portion 44 performs the update processing that adds, modifies, and deletes the index data 32 by applying to the index update database 26 the data that represent addition contents, modification contents and deletion contents in the index data 32 that are contained in the update data file 33. With regard to the update processing for the map update data 36, the difference update portion 44 performs the update processing that adds, modifies, and deletes the map update data 36 by applying to the map update database 27 the data that represent addition contents, modification contents and deletion contents in the map update data 36 that are contained in the update data file 33.

The replacement processing portion 45 is the functional portion that performs the replacement processing that replaces the contents of the reference databases 11 with the contents of the update databases 12 that have been updated by the difference update portion 44. Specifically, using the update data file 33 as described above, the replacement processing portion 45 replaces the contents of the ordinary location reference database 22, the index reference database 23, and the map reference database 24 that are included in the reference databases 11 with the contents of the ordinary location update database 25, the index update database 26, and the map update database 27 that are included in the updated update databases 12. As explained earlier, the contents of the ordinary location update database 25 are identical to those of the ordinary location reference database 22, and the contents of the index update database 26 are identical to those of the index reference database 23. Therefore, the ordinary location reference database 22 is updated by replacing the contents of the ordinary location reference database 22 by overwriting them with the contents of the updated ordinary location update database 25. Further, the index reference database 23 is updated by replacing the contents of the index reference database 23 by overwriting them with the contents of the updated index update database 26.

In contrast, as described earlier, the data formats of the map update database 27 and the map reference database 24 are different. Specifically, the map update data 36, which are the map data in the update format, are stored in the map update database 27, while the map reference data 35, which are the map data in the reference format, are stored in the map reference database 24. Accordingly, the replacement processing portion 45 first has the data format conversion portion 46, which is described below, perform the data format conversion processing that uses the update data file 33 to convert the map update data 36 in the updated map update database 27 into the map reference data 35 in the reference format. Then the replacement processing portion 45 updates the map reference database 24 by overwriting and replacing that contents of the map reference database 24 according to the data in the reference format. That completes the update processing for the reference databases 11. Note that, as described earlier, the newly added location database 21 that is included in the reference databases 11 is updated directly according to the update data file 33. Therefore, the replacement processing by the replacement processing portion 45 is not performed for the newly added location database 21.

The data format conversion portion 46 is the functional portion that performs the data format conversion processing that converts into the reference format the map update data 36 in the map update database 27 that has been updated by the difference update portion 44. In the present embodiment, the data format conversion portion 46 performs the processing that converts the map update data 36 in the update format into the map reference data 35 in the reference format that is suitable for reference by the navigation processing portion 48. More specifically, by converting a single set of the map update data 36, the data format conversion portion 46 creates the map reference data 35 that includes the plurality of sets of the map data that have different reference formats that are respectively suitable for the route search processing, the route guidance processing, the map display processing, and the like that are performed by the navigation processing portion 48.

Incidentally, as shown in FIG. 3, the update processing of the newly added location database 21, the ordinary location update database 25, the index update database 26, and the map update database 27 is performed automatically by the difference update portion 44 after the update data file 33 is acquired. In contrast, the replacement processing is performed by the replacement processing portion 45 on the condition that an update command has been input, the update command being a command that permits the updating of the reference databases 11. In the present embodiment, the input of the update command is performed through a display and input portion 51 that is shown in FIG. 1. Here, the display and input portion 51 is configured such that it has a combination touch panel and display device, as well as other operation switches and the like. As shown in FIG. 1, an Update Databases key 53, for example, may be displayed on the display and input portion 51, and the update command may be input by the operating (pressing) of the Update Databases key 53 by the user of the navigation device 1. The reason for the configuration that makes the input of the update command the condition for the performing of the replacement processing by the replacement processing portion 45 will now be explained. Essentially, during the replacement processing by the replacement processing portion 45, the contents of the reference databases 11 are being directly read and written, so the use of the reference databases 11 is restricted, and the functions of the navigation device 1, such as the location search, the route search, and the like, are also restricted. Accordingly, in order to prevent a situation from occurring in which the functions of the navigation device 1 are restricted when the user does not intend for them to be restricted, the input of the update command as a confirmation by the user has been made a condition for the performing of the replacement processing by the replacement processing portion 45.

1-5. Priority Processing Portion

The priority processing portion 47 is the functional portion that performs priority processing that, in a case where the location search command is input during the update processing by the update processing portion 43, gives priority to the performing of the update processing for the location data 31 that are stored in the newly added location database 21 and the ordinary location reference database 22 as the search databases 13. In the present embodiment, the priority processing portion 47 gives priority to the performing of the update processing for the newly added location data 31N that are added to the newly added location database 21, even during the update processing for the location data 31 that is performed by the difference update portion 44 of the update processing portion 43. Therefore, with respect to the difference update portion 44 of the update processing portion 43, the priority processing portion 47 gives a higher priority to the performing of the update processing of the newly added location database 21, which adds the newly added location data 31 to the newly added location database 21 as the newly added location data 31N, than it does to other processing that is performed by the update processing portion 43. Furthermore, in conjunction with this, in the present embodiment, the input of the location search command that serves as the condition (trigger) for the performing of the priority processing by the priority processing portion 47 effectively becomes the input of a command for a newly added location search that searches within the newly added location data 31N. Note that the processing for the newly added location search is performed by a search processing portion 49 of the navigation processing portion 48, which is described later. Here, the priority processing portion 47 is equivalent to a priority processing unit of the present invention.

As described above, in a case where the newly added location search command is input during the update processing by the update processing portion 43, the priority processing portion 47 functions and gives priority to the update processing for the newly added location database 21. In contrast, in a case where the newly added location search command is not input during the update processing by the update processing portion 43, the priority processing portion 47 does not function, and the update processing is performed according to the ordinary procedure. FIG. 3 shows a comparison of a time chart for the ordinary update processing by the update processing portion 43 and a time chart for the update processing in a case where the priority processing portion 47 functions and priority is given to performing the update processing for the newly added location database 21. FIG. 3 describes the procedure of the update processing by the update processing portion 43 in the form of time charts that are arranged in order from top to bottom according to the passage of time. In FIG. 3, the time chart on the left shows an example of the ordinary update processing by the update processing portion 43, and the time chart on the right shows an example of the update processing in the case where the priority processing portion 47 functions.

As shown in the time chart on the left in FIG. 3, in the ordinary update processing in which the priority processing portion 47 does not function, when the update data file 33 is acquired (S11), the difference update portion 44 first uses the update data file 33 to update the map update database 27 (S12). Next, the data format conversion portion 46 converts the map update data 36 in the updated map update database 27 into the map reference data 35 in the reference format (S13). Next, the difference update portion 44 uses the update data file 33 to update the update search databases 14 (S14). As described earlier, the update search databases 14 include the newly added location database 21, the ordinary location update database 25, and the index update database 26. Therefore, the update processing for the update search databases 14 includes the update processing for the newly added location database 21 using the update data file 33 (S14a). The processing described above is performed automatically after the update data file 33 is acquired. During the performance of S11 to S14 above, it is possible for the navigation processing portion 48 to reference the reference databases 11, so there are no restrictions on the functions of the navigation device 1. However, during the update processing for the newly added location database 21 (S14a), the function of the newly added location search that searches within the newly added location data 31N in the newly added location database 21 is restricted.

Next, a determination is made as to whether or not the user of the navigation device 1 has input the update command that is the command that permits the updating of the reference databases 11. The determination is made by determining whether or not the Update Databases key 53 on the display and input portion 51 has been operated (pressed) by the user (refer to FIG. 1). In a case where the update command has not been input, the subsequent update processing is not performed, and the processing is put into a standby state. In a case where the update command has been input, the replacement processing portion 45 replaces the contents of the map reference database 24 by overwriting them with the map reference data 35 that has been converted into the reference format from the map update data 36 that were updated at S13 (S15). Thus the map reference database 24 in the reference databases 11 is updated. Next, the replacement processing portion 45 replaces the contents of the search databases 13 by overwriting them with the contents of the update search databases 14 that were updated at S14 (S16). In the present embodiment, as described earlier, the newly added location database 21 has already been updated at S14a, so the processing that replaces the contents of the ordinary location reference database 22 by overwriting them with the contents of the updated ordinary location update database 25 and the processing that replaces the contents of the index reference database 23 by overwriting them with the contents of the updated index update database 26 are performed at S16. Thus the ordinary location reference database 22 and the index reference database 23 in the reference databases 11 are updated. During the replacement processing by the replacement processing portion 45 at S15 to S16, the contents of the reference databases 11 are being directly read and written, so the use of the reference databases 11 is restricted, and the functions of the navigation device 1, such as the location search, the route search, and the like, are also restricted. Therefore, in the ordinary update processing in which the priority processing portion 47 does not function, the newly added location search by the search processing portion 49 of the navigation processing portion 48, which is described later, is enabled only after the processing at S15 to S16 above is completed.

In contrast, as shown in the time chart on the right in FIG. 3, in the case where the newly added location search command is input during the update processing by the update processing portion 43, the priority processing portion 47 functions and gives priority to the update processing for the newly added location database 21. This time chart shows an example of a case where the newly added location search command is input during the update processing for the map update database 27. Note that the user is able to input the newly added location search command at any time. Therefore, in a case where the newly added location search command is input at any time during the update processing by the update processing portion 43, not only during the update processing for the map update database 27, the priority processing portion 47 immediately interrupts any other update processing and causes the update processing for the newly added location database 21 to be performed.

In the example in the time chart on the right in FIG. 3, when the update data file 33 is acquired (S21), the difference update portion 44 first uses the update data file 33 to update the map update database 27 (S22) in the same manner as in the ordinary processing. However, in this example, the newly added location search command is input during the update processing for the map update database 27. Therefore, the priority processing portion 47 immediately interrupts update processing for the map update database 27 that is being performed and causes the update processing for the newly added location database 21 to be performed. Specifically, the priority processing portion 47 causes the difference update portion 44 to perform the update processing that adds the newly added location data 31 that is contained in the update data file 33 to the newly added location database 21 as the newly added location data 31N. During the update processing for the newly added location database 21 (S23), the function of the newly added location search that searches within the newly added location data 31N in the newly added location database 21 is restricted. Immediately after the update processing for the newly added location database 21 (S23) is completed, the newly added location search in which the search processing portion 49 of the navigation processing portion 48 references the updated newly added location database 21 is enabled. Here, the completion of the update processing for the newly added location database 21 (S23) is a condition for putting the search processing portion 49 into a state in which the newly added location search is enabled, as will be described later.

Next, the difference update portion 44 performs the rest of the update processing for the map update database 27 (S24). The processing that is performed thereafter is the same as the ordinary update processing described above. That is, the processing that converts the map update data 36 in the updated map update database 27 into the map reference data 35 in the reference format is performed next (S25), and then the processing that uses the update data file 33 to update the update search databases 14 is performed (S26). Note that the processing at S26 does not include the update processing for the already updated newly added location database 21, so the processing time is shorter than the ordinary update processing (refer to the chart on the left in FIG. 3) to that extent. Next, in a case where the user of the navigation device 1 has input the update command that is the command that permits the updating of the reference databases 11, the processing is performed that replaces the contents of the map reference database 24 by overwriting them with the map reference data 35 that has been converted into the reference format from the updated map update data 36 (S27), and the processing is performed that replaces the contents of the search databases 13 by overwriting them with the contents of the updated update search databases 14 (S28).

1-6. Navigation Processing Portion

The navigation processing portion 48 is the processing portion that performs various types of navigation processing as the functions of the navigation device 1. When performing the various types of navigation processing, the navigation processing portion 48 references the various databases in the reference databases 11. The navigation processing portion 48 is also capable of exchanging various types of information and data with the display and input portion 51 described above. The navigation processing portion 48 causes images of various types of screens that are required for the navigation processing, such as menu screens for searches, settings, and the like, a map screen, a route guidance screen, and the like, to be displayed on the display and input portion 51 and also performs the various types of navigation processing, such as route searches, location searches, and the like, in accordance with commands that the user inputs from the display and input portion 51. The display and input portion 51 displays operation keys that are required on the various screens. In conjunction with the touch panel that is positioned on the front face of the display device of the display and input portion 51, the operation keys enable operation by the user. FIG. 1 shows an example in which a Search Newly Added Locations key 52 and the Update Databases key 53 are displayed on a single screen on the display and input portion 51 as the operation keys that are necessary for the explanations in this specification, but ordinarily, the display switches among a plurality of screens, and various types of command (instruction) keys such as these are grouped such that they are displayed on whatever screen is appropriate. In addition, a current position detection portion, an audio output portion, and the like that exchange various types of information and data are also connected to the navigation processing portion 48, although they are not shown in the drawings. Here, the current position detection portion is a functional portion for detecting the current position of the navigation device 1, and it is provided with a GPS receiver, a heading sensor, a distance sensor, and the like, for example. The audio output portion is configured such that it includes a speaker or the like, for example, and it outputs various types of information that pertain to the navigation processing, such as the route guidance and the like, in audio form.

The navigation processing portion 48 is also provided with the search processing portion 49 that performs various types of processing that pertain to searching for a location on a map. The search processing portion 49 is equivalent to a search unit of the present invention. The search processing portion 49 performs the location search processing by referencing the search databases 13 in the reference databases 11. As described earlier, the search databases 13 include the newly added location database 21, the ordinary location reference database 22, and the index reference database 23. In the present embodiment, the location search processing is broadly divided into newly added location search processing that searches within the newly added location data 31N in the newly added location database 21 and ordinary location search processing that searches within the location data 31 in the ordinary location reference database 22.

Here, the ordinary location search processing is search processing that references the location data 31 in the ordinary location reference database 22 and extracts the location data 31 that match a search condition that the user specifies by operating the display and input portion 51. During the ordinary location search processing, the search processing portion 49 utilizes the index data 32 in the index reference database 23 to extract the location data 31 that match the search condition. The search condition that is used for the ordinary location search processing may be, for example, a search condition for one of various types of search categories, such as a name search (a search in order according to the Japanese syllabary), an address search, a telephone number search, a genre search, and the like, a search condition that combines a plurality of the search categories, or the like. In the present embodiment, if the replacement processing is being performed by the replacement processing portion 45, that serves as a condition for the search processing portion 49 to prohibit the ordinary location search processing that references the index data 32. This is because the contents of the reference databases 11 are being directly read and written during the performing of the replacement processing by the replacement processing portion 45, so the use of the reference databases 11 is restricted.

In contrast, the newly added location search processing is search processing that references the newly added location data 31N in the newly added location database 21 and extracts the newly added location data 31N that match a search condition that the user specifies by operating the display and input portion 51. During the newly added location search processing, the search processing portion 49 does not utilize the index reference database 23, but extracts the newly added location data 31N that match the search condition by directly searching the contents of the newly added location data 31N in the newly added location database 21. In the same manner as in the ordinary location search processing, the search condition that is used for the newly added location search processing may be, for example, a search condition for one of various types of search categories, such as a name search (a search in order according to the Japanese syllabary), an address search, a telephone number search, a genre search, and the like, a search condition that combines a plurality of the search categories, or the like. Therefore, in a case where the user specifies a search condition such as a restaurant or the like that exists in the vicinity of the current position, for example, the search looks for information such as the positions (coordinates), addresses, telephone numbers, and the like among all of the newly added location data 31N that are stored in the newly added location database 21, and the newly added location data 31N that match the specified search condition are extracted. Note that because the quantity of the newly added location data 31N that are stored in the newly added location database 21 is less than the quantity of the location data 31 that are stored in the ordinary location reference database 22, this sort of processing can achieve a high search speed without causing any practical problems.

While the update processing for the newly added location database 21 is being performed by the difference update portion 44, the contents of the newly added location database 21 are being directly read and written, so the search processing portion 49 prohibits the newly added location search processing that references the newly added location database 21. This prohibition of the processing occurs both in the case where the priority processing portion 47 functions and in the case where the priority processing portion 47 does not function.

In a case where the ordinary update processing, in which the priority processing portion 47 does not function, is being performed for the reference databases 11, the search processing portion 49 prohibits the newly added location search processing, because the contents of the reference databases 11 are being directly read and written during the performing of the replacement processing by the replacement processing portion 45. Accordingly, in a state in which the priority processing portion 47 does not function, the search processing portion 49 is enabled to perform the newly added location search processing only after all of the replacement processing by the replacement processing portion 45 has been completed, as shown in the time chart on the left side of FIG. 3. In other words, in a case where the ordinary update processing is performed for the reference databases 11, the search processing portion 49 is put into a state in which it is enabled to perform the newly added location search processing only on the condition that the replacement processing by the replacement processing portion 45 (S15 and S16 in FIG. 3) has been completed.

In contrast, in a case where the priority processing portion 47 functions and gives priority to the performing of the update processing for the newly added location database 21, then immediately after the update processing for the newly added location database 21 is completed, as shown in the time chart on the right side of FIG. 3, the search processing portion 49 is enabled to perform the newly added location search processing that searches within the newly added location data 31N, including the data that have been newly added by the update processing. In other words, in a case where the priority processing portion 47 functions and gives priority to the performing of the update processing for the newly added location database 21, the condition for putting the search processing portion 49 into a state in which it is enabled to perform the newly added location search processing is that the update processing for the newly added location database 21 (S23 in FIG. 3) has been completed. In this case, the search processing portion 49 is enabled to perform the newly added location search processing even while the replacement processing is being performed by the replacement processing portion 45.

In addition to the search processing portion 49, the navigation processing portion 48 may also be provided with a display processing portion, a map matching processing portion, a route search processing portion, a route guidance processing portion, and the like, for example, although these are not shown in the drawings. The display processing portion, using the display and input portion 51, performs processing for the display of various types of information that pertain to the navigation processing, such as a map display, a current position display on the map, a route guidance display, and the like. The map matching processing portion performs map matching processing that matches the current position that is detected by the current position detection portion with a road on the map. The route search processing portion performs processing that searches for a guidance route or the like from a departure point such as the current position or the like to a destination that is input through the display and input portion 51. The route guidance processing portion performs processing that uses a guidance display on the display and input portion 51, audio guidance by the audio output portion, and the like to provide appropriate route guidance to the user in accordance with the route to the destination that was found by the route search processing portion. Note that the specific contents of the various types of navigation processing that are performed by these processing portions are publicly known, so a detailed explanation will be omitted.

1-7. Database Update Program

In a case where the various functional portions of the navigation device 1 that are explained above are configured from software (programs), the computational processing device with which the navigation device 1 is provided functions as a computer. Accordingly, a database update program that accepts the provided update data file 33 and performs the update processing for the reference databases 11 is configured from the various functional portions of the navigation device 1 described above. In this instance, a priority processing function of the database update program is implemented by the priority processing portion 47, and a search enabling function of the database update program is implemented by the search processing portion 49 of the navigation processing portion 48.

### 2. Second Embodiment

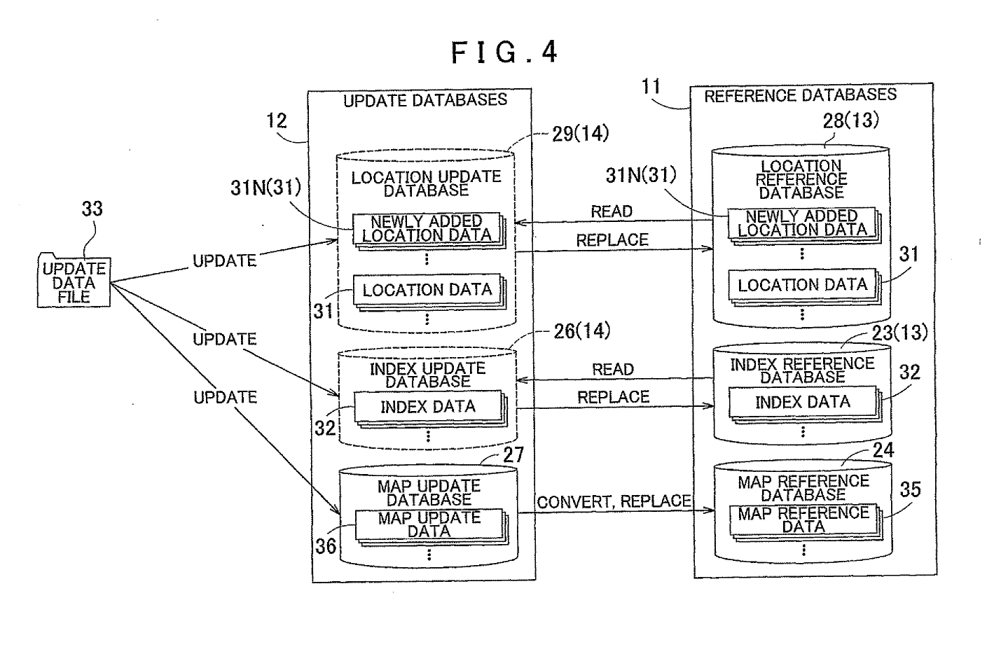

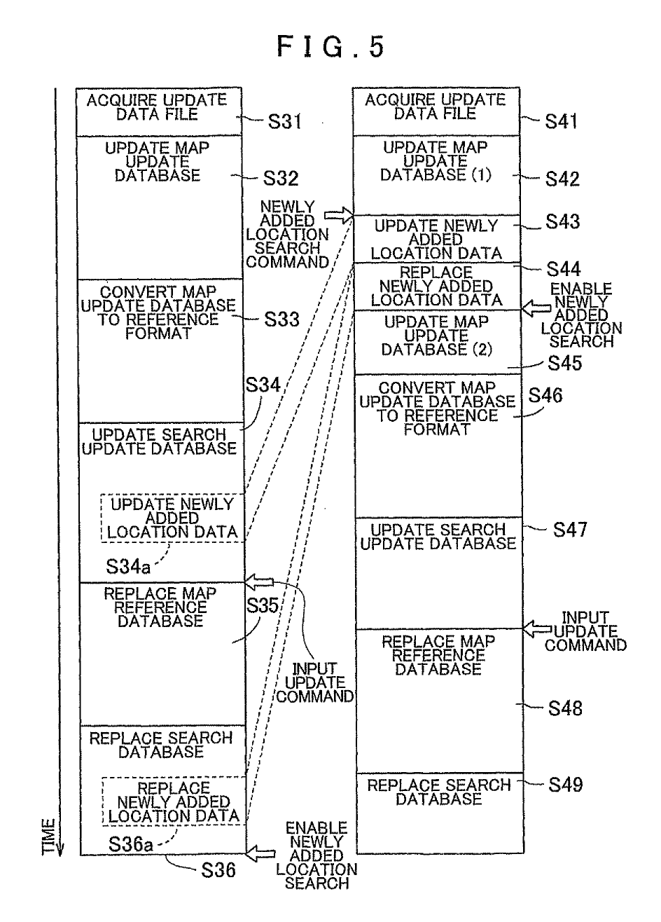

Next, a second embodiment of the present invention will be explained. FIG. 4 is an explanatory figure that shows a procedure in the present embodiment for updating the reference databases 11 according to the update data file 33. FIG. 5 is a figure that shows a comparison of an ordinary update processing time chart and an update processing time chart in a case where priority is given to performing the update processing for the location data 31 in the present embodiment. As shown in FIG. 4, the navigation device 1 according to the present embodiment, instead of being provided with the newly added location database 21, has a location reference database 28 that is configured such that it stores both the newly added location data 31N and the location data 31 other than the newly added location data 31N in a state in which they can be distinguished from one another. In correspondence to the location reference database 28, a location update database 29 is also configured such that it stores both the newly added location data 31N and the location data 31 other than the newly added location data 31N in a state in which they can be distinguished from one another. In conjunction with the differences in the database configuration from that in the first embodiment described above, the nature of the priority processing by the priority processing portion 47 in the navigation device 1 according to the present embodiment also differs from that in the first embodiment described above.

Note that in a block diagram that shows a functional configuration of the navigation device 1 according to the present embodiment, only the configuration of the databases that are included in the reference databases 11 and the update databases 12, as shown in FIG. 4, differs from that in the first embodiment described above, and the configuration is the same in all other respects. Therefore, FIG. 1 will be referenced as necessary in the explanation that follows. The navigation device 1 according to the present embodiment will be explained below, with the focus on the differences from the first embodiment described above. Accordingly, any points that are not explained below are the same as in the first embodiment described above.

2-1. Reference Databases

In the present embodiment, as shown in FIG. 4, the reference databases 11 include the location reference database 28, the index reference database 23, and the map reference database 24. Further, the search databases 13 that are referenced in conducting a search for a location on a map are configured from the location reference database 28 and the index reference database 23. In addition, in the present embodiment, the location reference database 28 is one of the location databases in which the location data 31 are stored.

In the same manner as the ordinary location reference database 22 according to the first embodiment described above, the location reference database 28 is a database that stores all of the location data 31 that the navigation device 1 has. However, the location reference database 28 stores the newly added location data 31N and the location data 31 other than the newly added location data 31N in a state in which they can be distinguished from one another. In the present embodiment, all of the location data 31 that are stored in the location reference database 28 are provided with date information, and the location data 31 are configured such that the newly added location data 31N and the rest of the location data 31 are distinguished from one another according to whether or not a condition for being the newly added location data 31N is satisfied, based on the date information. Here, the date information is information that indicates one of a date when the location data 31 was newly added to the location reference database 28 and a date when the location to which the location data 31 applies was actually enabled. The location data 31 is deemed to be the newly added location data 31N if the date that is indicated by the date information is within a specified period of time (for example, three months, one year) from the current date, the specified period of time defining the newly added location data 31N, and the rest of the location data 31, for which the specified period of time has elapsed, is deemed to be the ordinary location data 31. The search processing portion 49 that performs the newly added location search processing determines whether the location data 31 is the newly added location data 31N or the ordinary location data 31 by comparing the date information for the location data 31 to the current date.

2-2. Update Databases

The update databases 12 include the location update database 29, the index update database 26, and the map update database 27. In the present embodiment, the update search databases 14 are configured from the location update database 29 and the index update database 26. Here, the contents of the location update database 29 are identical to those of the location reference database 28. Therefore, the location update database 29 stores all of the location data 31 that the navigation device 1 has, and it stores the newly added location data 31N in a state in which they can be distinguished from the location data 31 other than the newly added location data 31N. Furthermore, in the same manner as the ordinary location update database 25 according to the first embodiment described above, the location update database 29 is configured such that it is provided within the update databases 12 only during the update processing according to the update data file 33, and it is deleted from the update databases 12 after the update processing (the replacement processing) for the location reference database 28 is finished. In other words, as shown in FIG. 4, the location update database 29 is created during the update processing according to the update data file 33 by reading the location reference database 28 and replicating (copying) it within the update databases 12. The update processing according to the update data file 33 is then performed for the location update database 29 that is created in this manner, and after the replacement processing is performed that replaces the contents of the location reference database 28 with the updated contents of the location update database 29, the location update database 29 is deleted from the update databases 12. Note that in order to illustrate this, the location update database 29 is indicated by a broken line in FIG. 4.

2-3. Update Processing Portion

The update processing portion 43 uses the update data file 33 to perform the update processing for the location update database 29, the index update database 26, and the map update database 27. Next, the update processing portion 43 performs the replacement processing that replaces the contents of the location reference database 28, the index reference database 23, and the map reference database 24 that are included in the reference databases 11 with the updated contents of the location update database 29, the index update database 26, and the map update database 27. This completes the update processing for the reference databases 11. In the present embodiment as well, the update processing portion 43 includes the difference update portion 44, the replacement processing portion 45, and the data format conversion portion 46, as shown in FIG. 1.

The difference update portion 44 performs the update processing for the location data 31 by taking the data that indicate the additions, modifications, and deletions in the location data 31 that are contained in the update data file 33 and applying them to the location update database 29 by performing the update processing that adds, modifies, and deletes the location data 31. At this time, the location data 31 that are the objects of the update processing that adds, modifies, and deletes include the existing newly added location data 31N that are stored in the location update database 29. Note that the location data 31 that are newly added by the difference update portion 44 are deemed to be the newly added location data 31N. Next, the replacement processing portion 45 performs the processing that replaces the contents of the location reference database 28 that is included in the reference databases 11 with the contents of the location update database 29 that were updated using the update data file 33. As described above, the contents of the location update database 29 are identical to those of the location reference database 28, so the location reference database 28 is updated by replacing the contents of the location reference database 28 by overwriting them with the contents of the updated location update database 29.

Incidentally, in the present embodiment, the update processing of the location update database 29, the index update database 26, and the map update database 27 is performed automatically by the difference update portion 44 after the update data file 33 is acquired, as shown in FIG. 5. In contrast, the replacement processing is performed by the replacement processing portion 45 on the condition that the update command that is the command that permits the updating of the reference databases 11 has been input. Here, the update command is input through the display and input portion 51 that is shown in FIG. 1.

2-4. Priority Processing Portion

The priority processing portion 47 performs the priority processing that, in a case where the location search command is input during the update processing by the update processing portion 43, gives priority to the performing of the update processing for the location data 31 that include the newly added location data 31N and that are stored in the location reference database 28 as one of the search databases 13. In the present embodiment, the priority processing portion 47 gives priority to the performing of the update processing for the newly added location data 31N that are added to the location update database 29. Therefore, with respect to the difference update portion 44 of the update processing portion 43, after the processing is performed that adds the newly added location data 31 that are included in the update data file 33 to the location update database 29 as the newly added location data 31N, the priority processing portion 47 gives a higher priority to the processing that replaces the contents of the location reference database 28 with the contents of the location update database 29 than it does to other processing that is performed by the update processing portion 43. FIG. 5 shows the comparison of the time chart for the ordinary update processing by the update processing portion 43 and the update processing time chart in the case where the priority processing portion 47 functions and priority is given to the update processing for the newly added location data 31N. FIG. 5 is organized in the same manner as FIG. 3 described above, with the time chart on the left showing an example of the ordinary update processing and the time chart on the right showing an example of the update processing in the case where the priority processing portion 47 functions.

As shown in the time chart on the left in FIG. 5, in the ordinary update processing in which the priority processing portion 47 does not function, when the update data file 33 is acquired (S31), the difference update portion 44 first uses the update data file 33 to update the map update database 27 (S32). Next, the data format conversion portion 46 converts the map update data 36 in the updated map update database 27 into the map reference data 35 in the reference format (S33). Next, the difference update portion 44 uses the update data file 33 to update the update search databases 14 (S34). Specifically, the update processing for the update search databases 14 includes the update processing for the location update database 29 and the update processing for the index update database 26. More specifically, the update processing for the location update database 29 includes the update processing for the newly added location data 31N that are stored in the location update database 29 (S34a). The processing described above is performed automatically after the update data file 33 is acquired. During the performance of S31 to S34 above, it is possible for the navigation processing portion 48 to reference all of the databases in the reference databases 11, so there are no restrictions on the functions of the navigation device 1, including the newly added location search function that searches among the newly added location data 31N.

Next, a determination is made as to whether or not the user of the navigation device 1 has input the update command that is the command that permits the updating of the reference databases 11. The determination is made in the same way as in the first embodiment described above. In a case where the update command has not been input, the subsequent update processing is not performed, and the processing is put into a standby state. In a case where the update command has been input, the replacement processing portion 45 replaces the contents of the map reference database 24 by overwriting them with the map reference data 35 that has been converted into the reference format from the map update data 36 that were updated at S33 (S35). Thus the map reference database 24 in the reference databases 11 is updated. Next, the replacement processing portion 45 replaces the contents of the search databases 13 by overwriting them with the contents of the update search databases 14 that were updated at S34 (S36). Specifically, the replacement processing for the location reference database 28 and the replacement processing for the index reference database 23 are included in the processing that replaces the contents of the search databases 13 with the contents of the update search databases 14. Further, in the present embodiment, the newly added location data 31N are contained in the location update database 29, so the replacement processing for the location reference database 28 includes the replacement processing for the newly added location data 31N that are stored in the location reference database 28 (S36a). Thus the location reference database 28 and the index reference database 23 in the reference databases 11 are updated. During the replacement processing by the replacement processing portion 45 at S35 to S36, the contents of the reference databases 11 are being directly read and written, so the use of the reference databases 11 is restricted, and the functions of the navigation device 1, such as the location search, the route search, and the like, are also restricted. Therefore, in the ordinary update processing in which the priority processing portion 47 does not function, the newly added location search by the search processing portion 49 of the navigation processing portion 48, which is described later, is enabled only after the processing at S35 to S36 above is completed.

In contrast, as shown in the time chart on the right in FIG. 5, in the case where the newly added location search command is input during the update processing by the update processing portion 43, the priority processing portion 47 functions and gives priority to the update processing for the newly added location data 31N. This time chart, in the same manner as FIG. 3 according to the first embodiment described above, shows an example of a case where the newly added location search command is input during the update processing for the map update database 27.

In the example in the time chart on the right in FIG. 5, when the update data file 33 is acquired (S41), the difference update portion 44 first uses the update data file 33 to update the map update database 27 (S42) in the same manner as in the ordinary processing. However, in this example, the newly added location search command is input during the update processing for the map update database 27. Therefore, the priority processing portion 47 immediately interrupts update processing for the map update database 27 that is being performed and causes the update processing and the replacement processing for the newly added location data 31N to be performed (S43 and S44). In the present embodiment, the priority processing portion 47 first performs the update processing for the newly added location data 31N (S43). Specifically, the priority processing portion 47 causes the difference update portion 44 to perform the update processing that adds the newly added location data 31 that is contained in the update data file 33 to the location update database 29 as the newly added location data 31N. Next, the priority processing portion 47 causes the processing to be performed that replaces the newly added location data 31N in the location reference database 28 with the contents of the newly added location data 31N that were updated at S44. Specifically, the priority processing portion 47 causes the replacement processing portion 45 to perform the processing that replaces the contents of the location reference database 28 with the contents of the location update database 29 that were updated at S43.

During the update processing and the replacement processing for the location reference database 28 (S43 and S44), the newly added location search function that searches among the newly added location data 31N in the location reference database 28 is restricted. Immediately after the update processing and the replacement processing for the location reference database 28 (S43 and S44) are completed, the search processing portion 49 of the navigation processing portion 48 is enabled to perform the newly added location search that references the updated newly added location data 31N. Here, the completion of the update processing and the replacement processing for the newly added location data 31N in the location reference database 28 (S43 and S44) is a condition for putting the search processing portion 49 into a state in which the newly added location search is enabled, as will be described later.

Next, the difference update portion 44 performs the rest of the update processing for the map update database 27 (S45). The processing that is performed thereafter is the same as the ordinary update processing described above. That is, the processing that converts the map update data 36 in the updated map update database 27 into the map reference data 35 in the reference format is performed next (S46), and then the processing that uses the update data file 33 to update the update search databases 14 is performed (S47). Note that the processing at S47 does not include the update processing for the already updated newly added location data 31N, so the processing time is shorter than the ordinary update processing (refer to the chart on the left in FIG. 5) to that extent. Next, in a case where the user of the navigation device 1 has input the update command that is the command that permits the updating of the reference databases 11, the processing is performed that replaces the contents of the map reference database 24 with the map reference data 35 that has been converted into the reference format from the updated map update data 36 (S48), and the processing is performed that replaces the contents of the search databases 13 with the contents of the updated update search databases 14 (S49). Note that the processing at S49 does not include the already completed replacement processing for the newly added location data 31N, so the processing time is shorter than the ordinary update processing (refer to the chart on the left in FIG. 5) to that extent.

2-5. Navigation Processing Portion

In the same manner as in the first embodiment described above, the location search processing that is performed by the search processing portion 49 of the navigation processing portion 48 is broadly divided into newly added location search processing and ordinary location search processing. However, in the present embodiment, the newly added location search processing is performed by searching only for the newly added location data 31N among all of the location data 31 that are stored in the location reference database 28, and the ordinary location search processing is performed by searching among all of the location data 31 that are stored in the location reference database 28, which include the newly added location data 31N. In all other respects, the content of the newly added location search processing and the content of the ordinary location search processing are the same as in the first embodiment described above.

Furthermore, in the present embodiment, in a case where the ordinary update processing, in which the priority processing portion 47 does not function, is being performed for the reference databases 11, the search processing portion 49 prohibits the newly added location search processing, because the contents of the reference databases 11 are being directly read and written during the performing of the replacement processing by the replacement processing portion 45. In other words, in a case where the ordinary update processing is performed for the reference databases 11, the search processing portion 49 is put into a state in which it is enabled to perform the newly added location search processing only on the condition that the replacement processing by the replacement processing portion 45 (S35 and S36 in FIG. 5) has been completed. In contrast, in a case where the priority processing portion 47 functions and gives priority to the performing of the update processing for the newly added location data 31N, then immediately after the update processing and the replacement processing for the newly added location data 31N are completed, as shown in the time chart on the right side of FIG. 5, the search processing portion 49 is enabled to perform the newly added location search processing that searches within the newly added location data 31N, including the data that have been newly added to the location reference database 28 by the update processing and the replacement processing. In other words, in a case where the priority processing portion 47 functions and gives priority to the performing of the update processing and the replacement processing for the newly added location data 31N, the condition for putting the search processing portion 49 into a state in which it is enabled to perform the newly added location search processing is that the update processing and the replacement processing for the location reference database 28 (S43 and S44 in FIG. 5) have been completed. In this case, the search processing portion 49 is enabled to perform the newly added location search processing even while the replacement processing for the map reference database 24 and the search databases 13 is being performed by the replacement processing portion 45.

### 3. Other Embodiments

(1) In each of the embodiments described above, an example was explained of a case in which the priority processing portion 47, in the case where the location search command is input during the update processing by the update processing portion 43, gives priority to the performing of the update processing for the location data 31 (the newly added location data 31N) that are newly added according to the update data file 33. However, the embodiments of the present invention are limited by these examples, and one preferred embodiment of the present invention may, for example, be configured such that the priority processing portion 47 gives priority to the performing of the update processing not only for the location data 31 that are newly added, but also for the location data 31 that are modified and deleted according to the update data file 33. It would also be preferable for the embodiment to be configured such that the priority processing portion 47 gives priority to performing not only the update processing for the location data 31, but also the update processing for the index data 32. In a case where the embodiment is configured in this manner, such that the priority processing portion 47 gives priority to performing the update processing for the location data 31 and the index data 32 in the various databases from which the search databases 13 are configured, it is possible to configure the embodiment such that, immediately after the update processing for the location data 31 and the index data 32 is completed by the priority processing unit, the search processing portion 49 is enabled to perform all of the location searching (the newly added location search processing and the ordinary location search processing described above) using the location data 31 and the index data 32 that have been updated by the update processing.

(2) In each of the embodiments described above, an example was explained of a case in which the navigation device 1 is provided with not only the reference databases 11, but also the update databases 12 that are the direct objects of the update processing according to the update data file 33. However, the embodiments of the present invention are limited by these examples. Accordingly, one preferred embodiment of the present invention may, for example, be configured such that the navigation device 1 is not provided with the update databases 12, and the reference databases 11 are the direct objects of the update processing according to the update data file 33. In this case, the embodiment is configured such that it is not necessary for the update processing portion 43 to be provided with the replacement processing portion 45 and the data format conversion portion 46, and the difference update portion 44 uses the update data file 33 to perform the updating of the various databases that are included in the reference databases 11.

(3) In each of the embodiments described above, an example was explained of a case in which the update processing for the update databases 12 is performed automatically after the update data file 33 is acquired, and the replacement processing that replaces the contents of the reference databases 11 with the updated contents of the update databases 12 is performed on the condition that the command that permits the updating of the reference databases 11 has been input. However, the embodiments of the present invention are limited by these examples. Accordingly, one preferred embodiment of the present invention may, for example, be configured such that all of the processing that is performed after the update data file 33 is acquired is performed on the condition that the command that permits the updating of the reference databases 11 has been input, and the embodiment may also be configured such that all of the processing that is performed after the update data file 33 is acquired is performed automatically. It is also preferable for the embodiment to be configured such that the procedure for the update processing can be set as the user desires.

(4) In the first embodiment described above, an example was explained of a case in which the newly added location database 21 is included in the reference databases 11 that are referenced directly by the navigation processing portion 48 and is the direct object of the update processing according to the update data file 33. However, the embodiments of the present invention are limited by this example. Accordingly, one preferred embodiment of the present invention may, for example, be configured such that the newly added location database 21 is not the direct object of the update processing according to the update data file 33, and a newly added location update database that corresponds to the newly added location database 21 is provided among the update databases 12.

(5) In the second embodiment described above, an example was explained of a case in which the location data 31 that is stored in the location reference database 28 is provided with the date information, and based on the date information and the current date, the location data 31 for which the date information is within a specified period of time from the current date is deemed to be the newly added location data 31N. However, the embodiments of the present invention are limited by this example, and one preferred embodiment of the present invention may, for example, be configured such that each item of the location data 31 that are stored in the location reference database 28 is provided with newly added flag information that indicates whether or not the item is the newly added location data 31N. In this case, the database management portion 50 determines whether or not the newly added flag information is valid, based on one of the time when the location data 31 item was newly added to the location reference database 28, the time period from the time that the location to which the location data 31 item applies was actually enabled to the current date, or the like, and performs rewriting or the like of the newly added flag information. Then the search processing portion 49 that performs the newly added location search processing refers to the newly added flag information in each of the location data 31 items in order to determine whether the item is the one of the newly added location data 31N and the ordinary location data 31.

(6) In each of the embodiments described above, an example was explained of a case in which a time period condition is set as the condition that defines the newly added location data 31N, such as whether the times that the location data 31 were newly added to the newly added location database 21 and the times that the locations to which the location data 31 apply were actually enabled are within a specified period of time. However, the embodiments of the present invention are limited by these examples. Accordingly, one preferred embodiment of the present invention may, in a case where the update data file 33 is provided at regular intervals, such as every week, every month, every year, or the like, for example, set the condition that defines the newly added location data 31N to a condition that pertains to the number of updates. In this case, it is possible to define the newly added location data 31N as the location data 31 that have been newly added according to the three most recent update data files 33, for example, and it is also possible to define the newly added location data 31N as the location data 31 that have been newly added according to only the most recent update data file 33.

The present invention can be used in various types of navigation devices, including vehicle-mounted devices, portable devices, and the like.

1. A navigation device that is provided with reference databases that comprise search databases that are referenced when the navigation device performs a location search for a location on a map, that accepts provided update data, and that performs update processing for the reference databases, the navigation device comprising:
a priority processing unit that, in a case where a command to perform the location search is input during the update processing for the reference databases, gives priority to performing the update processing for location data that are stored in the search databases; and
a search unit that, after the update processing for the location data is completed by the priority processing unit, is enabled to perform the location search using the updated location data.

2. The navigation device according to claim 1, wherein
the priority processing unit gives priority to performing, as the update processing for the location data, the update processing for the location data that will be newly added.

3. The navigation device according to claim 2, wherein
the search unit, immediately after the update processing for the location data is completed by the priority processing unit, is enabled to perform the location search among the newly added location data that comprise the location data that were newly added by the update processing.

4. The navigation device according to claim 1, further comprising:
update databases that are provided in correspondence to the reference databases and that are direct objects of the update processing according to the update data,
wherein
the update processing for the reference databases comprises the update processing for the update databases according to the update data and replacement processing that replaces the reference databases with contents of the updated update databases.

5. The navigation device according to claim 4, wherein
the update processing for the update databases is performed automatically after the update data are acquired, and
the replacement processing is performed on the condition that a command that permits the updating of the reference databases has been input.

6. The navigation device according to claim 1, wherein
the search databases comprise location databases in which the location data are stored and an index database in which are stored index data for searching among the location data.

7. The navigation device according to claim 6, wherein
the location databases comprise a newly added location database that stores the newly added location data that include the location data that were newly added by the update processing for the location data that was performed by the priority processing unit and an ordinary location database that stores all of the location data.

8. The navigation device according to claim 7, wherein
the newly added location database is a direct object of the update processing according to the update data, and
the priority processing unit gives priority to performing, as the update processing for the location data, processing that adds to the newly added location database the location data that will be newly added, the location data being included in the update data.

9. The navigation device according to claim 6, wherein
the location databases store the location data in a state in which the newly added location data that comprise the location data that were newly added by the update processing for the location data that was performed by the priority processing unit can be distinguished from the location data other than the newly added location data.

10. The navigation device according to claim 9, wherein
the priority processing unit gives priority to performing processing that replaces the location databases that are comprised of the reference databases with contents of the updated location update database after processing that adds to a location update database that is comprised of the update databases the location data that will be newly added that are included in the update data, as the update processing for the location data.

11. The navigation device according to claim 3, wherein
the newly added location data are the location data for which one of the times that the location data were newly added and the times that the locations to which the location data apply were actually enabled are within a specified period of time.

12. A database update program that accepts provided update data and performs update processing for reference databases that comprise search databases that are referenced when a location search is performed for a location on a map, the database update program causing a computer to execute the following functions:
a priority processing function that, in a case where a command to perform the location search is input during the update processing for the reference databases, gives priority to performing the update processing for location data that are stored in the search databases; and
a search enabling function that, after completion of the update processing for the location data that is performed by the priority processing unit, makes it possible for the location search to be performed using the updated location data.
